(19) United States
(12) Patent Application Publication
(10) Pub. No.: US 2020/0127830 A1
(43) Pub. Date: Apr. 23, 2020

(54) APPARATUS AND METHOD FOR ENCRYPTION AND DECRYPTION

(71) Applicant: SAMSUNG SDS CO., LTD., Seoul (KR)

(72) Inventors: Eun-Kyung KIM, Seoul (KR); Hyo-Jin YOON, Seoul (KR)

(21) Appl. No.: 16/660,916

(22) Filed: Oct. 23, 2019

(30) Foreign Application Priority Data
Oct. 23, 2018 (KR) 10-2018-0126802

(51) Int. Cl. H04L 9/30; H04L 9/08; H04L 9/00

(52) U.S. Cl. CPC H04L 9/3073; H04L 9/008; H04L 9/3093; H04L 9/085

(57) ABSTRACT

An apparatus may perform encryption and/or decryption. An encryption method includes generating a public key share of a user, receiving public key shares of one or more other users from terminals of the one or more other users, generating a public key using the public key share of the user and the public key shares of the one or more other users, and encrypting plaintext using the public key.

### CROSS-REFERENCE TO RELATED APPLICATION

This application claims priority to and the benefit of Korean Patent Application No. 10-2018-0126802, filed on Oct. 23, 2018, the disclosure of which is incorporated herein by reference in its entirety.

### BACKGROUND

### 1. Field

Embodiments of the present disclosure relate to a technique for encryption and decryption.

### 2. Discussion of Related Art

In a related art including U.S. Pat. No. 9,252,942, a reliable user (a secret key manager) generates a public key and a secret key and distributes the public key to all of a plurality of users in order to provide a stable data convergence service to the users using homomorphic encryption. In this case, the users may encrypt their own data using the distributed public key and then perform homomorphic evaluation of the encrypted data. Also, when general users send a description request to the secret key manager, the secret key manager transmits a decrypted plaintext evaluation result to the general users.

In such a related art, a secret key manger manages a secret key, and thus the safety of the entire system depends entirely on the safety of the secret key manager. That is, when the secret key is leaked through the secret key manager, data of all the users can be recovered, and the safety of the whole system is damaged. Furthermore, for users who cannot trust each other, it is not possible to set only one secret key manger that all the users can trust.

### SUMMARY

Embodiments of the present disclosure are directed to providing an apparatus and method for encryption and decryption.

According to an aspect of the present disclosure, an encryption method performed by a computing apparatus including one or more processors and a memory for storing one or more programs executed by the one or more processors includes generating a public key share of a user, receiving public key shares of one or more other users from terminals of the one or more other users, generating a public key using the public key share of the user and the public key shares of the one or more other users, and encrypting plaintext using the public key.

The generating of the public key share may include generating a private key share of the user and generating a public key share of the user using the private key share of the user.

The public key shares of the one or more other users may be generated using private key shares of the one or more other users.

The encryption method may further include providing the generated public key share to the terminals of the one or more other users.

According to another aspect of the present disclosure, an encryption apparatus includes one or more processors, a memory, and one or more programs, wherein the one or more programs are stored in the memory and executed by the one or more processors, and the programs include instructions for generating a public key share of a user, receiving public key shares of one or more other users from terminals of the one or more other users, generating a public key using the public key share of the user and the public key shares of the one or more other users, and encrypting plaintext using the public key.

The generating of the public key share may include generating a private key share of the user and generating a public key share of the user using the private key share of the user.

The public key shares of the one or more other users may be generated using private key shares of the one or more other users.

The program may further include instructions for providing the generated public key share to the terminals of the one or more other users. According to another aspect of the present disclosure, a decryption method performed by a computing apparatus including one or more processors and a memory for storing one or more programs executed by the one or more processors includes generating a partial decryption result for a ciphertext encrypted with a public key by using a private key share of a user, requesting terminals of one or more other users to perform partial decryption for the ciphertext, receiving partial decryption results for the ciphertext using private key shares of the one or more other users from the one or more other user terminals, and generating plaintext for the ciphertext using the generated partial decryption result and the partial decryption results received from the one or more other users.

The public key may be generated using a public key share of the user and public key shares of the one or more other users.

The public key share of the user may be generated using the private key share of the user, and the public key shares of the one or more other users may be generated using the private key shares of the one or more other users.

The ciphertext may be a ciphertext generated by evaluating a plurality of ciphertexts encrypted with the public key in an encrypted state.

The plaintext may be a result of performing evaluation on plaintexts for the plurality of ciphertexts.

The ciphertext may be a ciphertext generated by adding the plurality of ciphertexts encrypted with the public key in an encrypted state.

The plaintext may be a result of adding plaintexts for the plurality of ciphertexts.

The generating of the plaintext may include generating plaintext for the ciphertext by adding the generated partial decryption result and the partial decryption results received from the one or more other users.

According to another aspect of the present disclosure, a decryption apparatus includes one or more processors, a memory, and one or more programs, wherein the one or more programs are stored in the memory and executed by the one or more processors, and the program includes instructions for generating a partial decryption result for a ciphertext encrypted with a public key by using a private key share of a user, requesting terminals of one or more other users to perform partial decryption of the ciphertext, receiving partial decryption results for the ciphertext using private key shares of the one or more other users from the one or more other user terminals, and generating plaintext for the ciphertext using the generated partial decryption result and the partial decryption results received from the one or more other users.

The public key may be generated using a public key share of the user and public key shares of the one or more other users.

The public key share of the user may be generated using the private key share of the user, and the public key shares of the one or more other users may be generated using the private key shares of the one or more other users.

The ciphertext may be a ciphertext generated by evaluating a plurality of ciphertexts encrypted with the public key in an encrypted state.

The plaintext may be an evaluation result between plaintexts for the plurality of ciphertexts.

The ciphertext may be a ciphertext generated by adding the plurality of ciphertexts encrypted with the public key in an encrypted state.

The plaintext may be a result of adding plaintexts for the plurality of ciphertexts.

The generating of the plaintext may include generating plaintext for the ciphertext by adding the generated partial decryption result and the partial decryption results received from the one or more other users.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of an encryption system according to an embodiment of the present disclosure;

FIG. 2 is a sequence diagram showing a public key generation process according to an embodiment of the present disclosure;

FIG. 3 is a sequence diagram showing a decryption process according to an embodiment of the present disclosure; and

FIG. 4 is a block diagram illustrating a computing environment including a computing apparatus suitable for use in example embodiments.

### DETAILED DESCRIPTION

Hereinafter, exemplary embodiments of the present disclosure will be described with reference to the accompanying drawings. The following detailed description is provided to assist the reader in gaining a comprehensive understanding of methods, apparatuses, and/or systems described herein. However, this is merely an example, and the present disclosure is not limited thereto.

In describing embodiments of the present disclosure, when it is determined that a detailed description of a known technique associated with the present disclosure would unnecessarily obscure the subject matter of the present disclosure, the detailed description will be omitted. Also, terms used herein are defined in consideration of functions used in the present disclosure and may be changed depending on a user, the intent of an operator, or a custom. Therefore, the definitions should be made based on the contents throughout the specification. The terminology used herein is only for the purpose of describing embodiments of the present disclosure and should not be limiting. The singular forms “a,” “an,” and “the” are intended to include the plural forms as well, unless the context clearly indicates otherwise. It should be understood that the terms “comprises,” “comprising,” “includes,” “includes,”: and/or “including” specify the presence of stated features, integers, steps, operations, elements, components, and/or groups thereof when used herein, but do not preclude the presence or addition of one or more other features, integers, steps, operations, elements, components, and/or groups thereof.

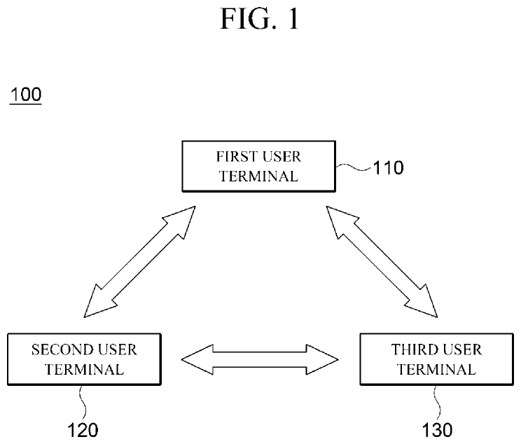

FIG. 1 is a block diagram of an encryption system according to an embodiment of the present disclosure.

Referring to FIG. 1, an encryption system 100 according to an embodiment of the present disclosure includes a plurality of user terminals 110, 120, and 130.

The encryption system 100 is configured to generate a ciphertext using a public key generated by a plurality of users in cooperation. Only when all of the users agree does the encryption system 100 enable the ciphertext generated using the public key to be decrypted or enable a result of performing evaluation on ciphertexts generated using the public key to be decrypted.

The plurality of user terminals 110, 120, and 130 are terminals that are used by different users, for example, desktop personal computers (PCs), laptop PCs, tablet PCs, smartphones, phablets, and the like. However, any device may be used as long as the device has a communication function and a data evaluation function using a wired/wireless network, and the present disclosure is not necessarily limited to a particular type of device.

In the following description, for convenience of description, it is assumed that there are three user terminals 110, 120, and 130 as shown in FIG. 1. However, the number of terminals may be two or four or more depending on the embodiment. In the following description, it is also assumed that the first user terminal 110 is used by a first user, the second user terminal 120 is used by a second user, and the third user terminal 130 is used by a third user.

According to an embodiment of the present disclosure, an encryption and decryption process performed by the user terminals 110, 120, and 130 may be performed as follows.

Key Generation

Each of the user terminals 110, 120, and 130 generates a private key share and a public key share for the user of the corresponding one of the user terminals 110, 120, and 130 and transmits the public key share to the others user terminals 110, 120, and 130.

Also, each of the user terminals 110, 120, and 130 that has received the public key shares of the other users generates the same public key using the generated user key share of the user and the received public key shares of the other users.

Enceryption and Homomoephic Evaluation

When a public key is generated, each of the user terminals 110, 120, and 130 generates a ciphertext for plaintext using the generated public key.

In this case, the generated ciphertext may be stored in the corresponding one of the user terminals 110, 120, and 130. In some embodiments, however, the generated ciphertext may be stored in a separate database (not shown) or a separate server (not shown) accessible by the user terminals 110, 120, and 130.

The ciphertext may be generated by the user terminals 110, 120, and 130 using various types of homomorphic encryption techniques capable of evaluating a plurality of ciphertexts encrypted with the same public key in an encrypted state and generating a ciphertext for a result of performing evaluation on plaintext values for each ciphertext. In this case, each of the user terminals 110, 120, and 130 may perform evaluation on the ciphertexts to generate the ciphertext for the result of evaluating the plaintext values for each ciphertext. In this case, each of the ciphertexts used for the evaluation may be generated by the same user terminal 110, 120, or 130 or by different user terminals 110, 120, and 130.

The evaluation on the ciphertexts may be performed by each of the user terminals 110, 120, and 130, as described above. In some embodiments, however, when the ciphertext generated by the user terminals 110, 120, and 130 is stored in a separate server (not shown), the corresponding server may perform evaluation on the stored ciphertexts and then provide the result to the user terminals 110, 120, and 130.

Decryption

Each of the user terminals 110, 120, and 130 performs partial decryption on the ciphertext using a private key share of the user of the corresponding one of the user terminals 110, 120, and 130. Plaintext for the ciphertext is generated using the results of the partial decryption performed by the user terminals 110, 120, and 130. In this case, the ciphertext may be a ciphertext encrypted with the public key or a ciphertext generated through evaluation on the plurality of ciphertexts encrypted with the public key.

A specific application example of applying the above-described encryption and decryption process to a homomorphic encryption technique capable of approximation is as follows.

Key Generation

First, each of the user terminals 110, 120, and 130 may generate a private key share and a public key share of a user of the corresponding user terminal 110, 120, or 130. In this case, a private key share ski and a public key share pkᵢ of user i (here, i is a user index of 1≤i≤3) may satisfy Equation 1 and Equation 2 below:

skᵢ=(1, sᵢ) [Equation 1]

pkᵢ=(bᵢ, a) [Equation 2]

where sᵢ, bᵢ, and a are elements of a polynomial ring and can satisfy bᵢ=−a·sᵢ+e (here, e is any very small error value). Also, a may be a value included in the public key shares of all the users in common.

Subsequently, each of the user terminals 110, 120, and 130 may transmit the generated public key share to the others of the user terminals 110, 120, and 130. Also, each of the user terminals 110, 120, and 130 having received the public key shares from the others of the user terminals 110, 120, and 130 may generate a public key pk using the received public key shares and the public key share generated by the corresponding user terminal 110, 120, or 130 itself. In this case, the public key pk may be generated using, for example, Equation 3:

pk=(bᵢ+b₂+b₃, a)=(b, a). [Equation 3]

Encryption

When the public key is generated, each of the user terminals 110, 120, and 130 may generate a ciphertext C for plaintext m using the generated public key. In this case, the ciphertext may be generated using, for example, Equation 4 below:

C=(c₀, c₁)=(v·b+m+e₀, v·a+e₁) [Equation 4]

where plaintext m and v are elements of a polynomial ring, and e₀ and e₁ are any very small error values.

Meanwhile, the generated ciphertext may be stored in the corresponding one of the user terminals 110, 120, and 130. In some embodiments, however, the ciphertext may be stored in a separate database (not shown) or a separate server (not shown) accessible by the user terminals 110, 120, and 130.

Homomorphic Evaluation

Each of the user terminals 110, 120, and 130 may add a ciphertext C₁ for plaintext m₁ and a ciphertext C₂ for plaintext m₂, which are generated through the above encryption process, to calculate C₁+C₂ and thus may generate a ciphertext C3 for m₁+m₂. In detail, when the ciphertext C₁ and the ciphertext C₂ are expressed as Equation 5 and Equation 6, C₃ may be generated using Equation 7 below.

C₁=(c_{1,0}, c_{1,1})=(v₁·b+m₁+e_{0,1}, v₂·a+e_{1,1}) [Eqution 5]

C₂=(c_{2,0}c_{2,1})=(v₂·b+m₂+e_{0,2}, v₂·a+e_{1,2}) [Equation 6]

C₃=C₁+C₂=(c_{3,0}, c_{3,1})=(v₃·b+m₃+e_{0,3}, v₃·a+e_{1,3}) [Equation 7]

where v₃=v₁+v₂, e_{0,3}=e_{0,1}+e_{0,2}, and e_{1,3}=e_{1,1}+e_{1,2} are satisfied.

In some embodiments, unlike the above example, the generation of the ciphertext C₃ may be performed by a server (not shown) for storing the ciphertext C₁ and the ciphertext C₂. In this case, the server (not shown) may provide the generated ciphertext C₃ to the user terminals 110, 120, and 130.

Decryption

Each of the user terminals 110, 120, and 130 may perform partial decryption of the ciphertext C′=(c′₀, c′₁) using a private key share skᵢ for a user of each of the user terminals 110, 120, and 130. In this case, a ciphertext C′ may be a ciphertext (e.g., C₁ or C₂) generated through the above encryption process or a ciphertext (e.g., C₃) generated through the above homomorphic evaluation process.

The partial decryption of the ciphertext C′ may be performed using, for example, Equation 8 below:

pᵢ=c′₁·sᵢ+e′₄=v′·a·sᵢ+e′₁·sᵢ+e′₄ [Equation 8]

where e′₄ indicates any very small error value.

Meanwhile, plaintext m′ for the ciphertext C′ may be generated using, for example, Equation 9 below:

$$\begin{matrix}{c}_{0}^{′} + ( {p}_{1} + {p}_{2} + {p}_{3} ) = ( {v}^{′} \cdot {\sum }_{i = 1}^{3} {b}_{i} + {m}^{′} + {e}_{0}^{′} ) + \\ {\sum }_{i = 1}^{3} ( {v}^{′} \cdot α \cdot {s}_{i} + {e}_{1}^{′} \cdot {s}_{i} + {e}_{4}^{′} ) \\ = {m}^{′} + {v}^{′} \cdot {\sum }_{i = 1}^{3} ( {b}_{i} + a \cdot {s}_{i} ) + \\ {\sum }_{i = 1}^{3} ( {e}_{1}^{′} \cdot {s}_{i} + {e}_{4}^{′} ) + {e}_{0}^{′} \\ = {m}^{′} + {e}_{5}^{′} \approx {m}^{′}\end{matrix} \qquad [ Equation 9 ]$$

In Equation 3, e′₅=v′·Σᵢ₌₁³(bᵢ+a·sᵢ)+Σᵢ₌₁³(e′₁·s₁+e′₄)+e′₀ may be satisfied and may be set to be a value much smaller than m′.

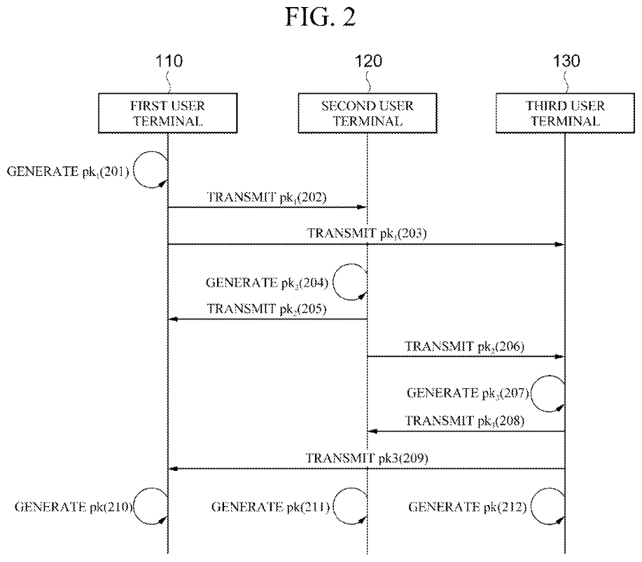

FIG. 2 is a sequence diagram showing a public key generation process according to an embodiment of the present disclosure.

Referring to FIG. 2, a first user terminal 110 generates a public key share pki for a first user (201).

Subsequently, the first user terminal 110 transmits the public key share pk₁ to a second user terminal 120 and a third user terminal 130 (202, 203).

Subsequently, the second user terminal 120 generates a public key share pk₂ for a second user (204).

Subsequently, the second user terminal 120 transmits the public key share pk₂ to the first user terminal 110 and the third user terminal 130 (205, 206).

Subsequently, the third user terminal 130 generates a public key share pk₃ for a third user (207).

Subsequently, the third user terminal 130 transmits the public key share pk₃ to the first user terminal 110 and the second user terminal 120 (208, 209).

Subsequently, the first user terminal 110, the second user terminal 120, and the third user terminal 130 generate a public key pk using pk₁, pk₂, and pk₃ (210, 211, 212).

In FIG. 2, the public key generation process has been described as having a plurality of steps. However, at least some of the steps may be performed in a changed order, performed in combination with another step, omitted, divided into sub-steps and then performed, or performed in addition to one or more steps that are not shown.

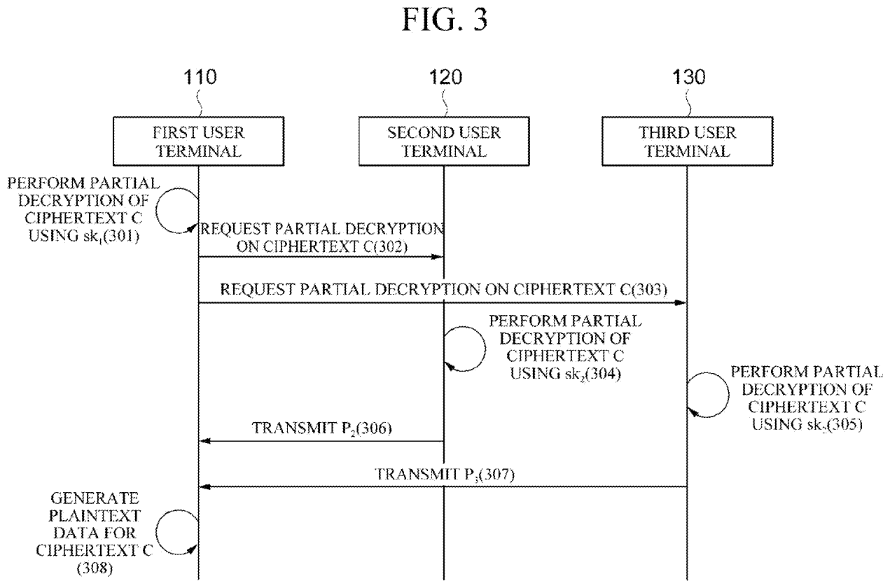

FIG. 3 is a sequence diagram showing a decryption process according to an embodiment of the present disclosure.

Referring to FIG. 3, first, the first user terminal 110 generates a partial decryption result p₁ for the ciphertext C using the private key share sk₁ of the first user (301).

In this case, the ciphertext C may be an evaluation result of a ciphertext encrypted with the public key pk generated using the public key generation process shown in FIG. 2 or a result of performing evaluation on a plurality of ciphertexts encrypted with the public keys pk.

Subsequently, the first user terminal 110 requests the second user terminal 120 and the third user terminal 130 to perform partial decryption of the ciphertext C (302, 303).

In this case, for example, when the ciphertext C is stored in the first user terminal 110, the first user terminal 110 may transmit the ciphertext C to the second user terminal 120 and the third user terminal 130 to request partial decryption of the ciphertext C.

As another example, when the ciphertext C is stored in a separate database (not shown) or a separate server (not shown) accessible by the first user terminal 110, the second user terminal 120, and the third user terminal 130, the first user terminal 110 may request the second user terminal 120 and the third user terminal 130 to perform partial decryption of the ciphertext C stored in the database (not shown) or the server (not shown).

When the second user terminal 120 is requested to perform the partial decryption of the ciphertext C by the first user terminal 110, the second user terminal 120 generates a partial decryption result p₂ for the ciphertext C using the private key share sk₂ of the second user (304).

Also, when the third user terminal 130 is requested to perform the partial decryption of the ciphertext C by the first user terminal 110, the third user terminal 130 generates a partial decryption result p₃ for the ciphertext C using the private key share sk₃ of the third user (305).

Subsequently, the second user terminal 120 and the third user terminal 130 transmit the generated partial decryption results p₂ and p₃ to the first user terminal 110 (306, 307).

Subsequently, the first user terminal 110 generates plaintext for the ciphertext C using the partial decryption results p₁, p₂, and p₃ (308).

In the sequence diagram illustrated in FIG. 3, the decryption process has been described as having a plurality of steps. However, at least some of the steps may be performed in a changed order, performed in combination with another step, omitted, divided into sub-steps and then performed, or performed in addition to one or more steps that are not shown.

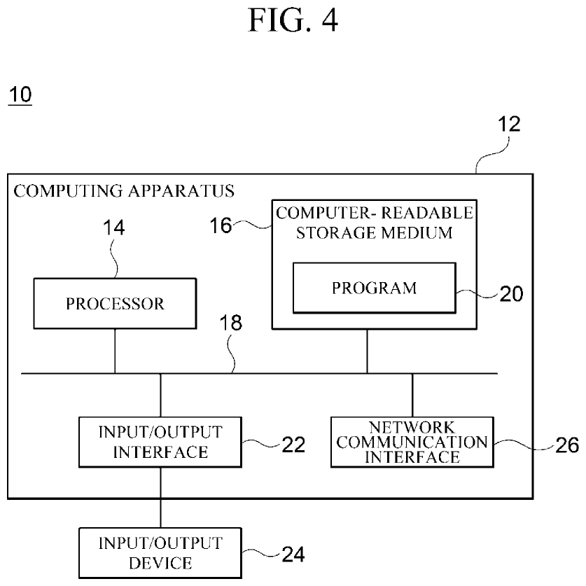

FIG. 4 is a block diagram illustrating a computing environment including a computing apparatus suitable for use in example embodiments. In the illustrated embodiment, each component may have a function and capability that differs from those described below, and an additional component may be included in addition to those in the following description.

As shown, a computing environment 10 includes a computing apparatus 12. According to an embodiment, the computing apparatus 12 may be one or more components included in each of the user terminals 110, 120, and 130.

The computing apparatus 12 includes at least one processor 14, a computer-readable storage medium 16, and a communication bus 18. The processor 14 may enable the computing apparatus 12 to operate according to the aforementioned example embodiment. For example, the processor 14 may execute one or more programs stored in the computer-readable storage medium 16. The one or more programs may include one or more computer executable instructions which may be configured to enable the computing apparatus 12 to perform operations according to an example embodiment when they are executed by the processor 14.

The computer-readable storage medium 16 is configured to store computer-executable instructions, program codes, program data, and/or other suitable forms of information. The program 20 stored in the computer-readable storage medium 16 includes a set of instructions executable by the processor 14. In an embodiment, the computer-readable storage medium 16 may be a memory (a volatile memory such as a random access memory, a non-volatile memory, or an appropriate combination thereof), one or more magnetic disk storage devices, optical disk storage devices, flash memory devices, other forms of storage media that may be accessed by the computing apparatus 12 and are configured to store desired information, or a suitable combination thereof.

The communication bus 18 connects the processor 14, the computer-readable storage medium 16, and various other components of the computing apparatus 12 to one another.

Also, the computing apparatus 12 may include one or more input/output interfaces 22 for providing an interface for one or more input/output devices 24, and one or more network communication interfaces 26. The input/output interfaces 22 and the network communication interfaces 26 are connected to the communication bus 18. The input/output devices 24 may be connected to other components of the computing apparatus 12 through the input/output interfaces 22. The input/output devices 24 may include input devices such as a pointing device (a mouse, a track pad, etc), a keyboard, a touch input device (a touchpad, a touch screen, etc.), a voice or sound input device, various kinds of sensor devices, and/or a capture device and/or may include output devices such as a display device, a printer, a speaker, and/or a network card. The input/output devices 24 may be included in the computing apparatus 12 as components of the computing apparatus 12 and may be connected to the computing apparatus 12 as separate devices distinct from the computing apparatus 12.

According to the embodiments of the present disclosure, by distributing secret key management authority equally to all users who have cooperated to generate a public key and allowing decryption only when all of the users agree, it is possible to prevent unauthorized data leakage due to private key leakage and also to enable secure private key management even between users who lack mutual trust.

Although the disclosure has been described in detail with reference to exemplary embodiments, it will be understood by those skilled in the art that various changes may be made without departing from the spirit or scope of the disclosure. Therefore, the scope of the present disclosure is not to be construed as being limited to the described embodiments, but is defined by the appended claims as well as equivalents thereto.

What is claimed is:

1. An encryption method performed by a computing apparatus including one or more processors and a memory for storing one or more programs executed by the one or more processors, the encryption method comprising:
generating a public key share of a user;
receiving public key shares of one or more other users from terminals of the one or more other users;
generating a public key using the public key share of the user and the public key shares of the one or more other users; and
encrypting plaintext using the public key.

2. The encryption method of claim 1, wherein the generating of the public key share comprises:
generating a private key share of the user; and
generating a public key share of the user using the private key share of the user.

3. The encryption method of claim 2, wherein the public key shares of the one or more other users are generated using private key shares of the one or more other users.

4. The encryption method of claim 1, further comprising providing the generated public key share to the terminals of the one or more other users.

5. An encryption apparatus comprising:
one or more processors;
a memory; and
one or more programs, wherein the one or more programs are stored in the memory and executed by the one or more processors; and
the programs comprise instructions for:
generating a public key share of a user;
receiving public key shares of one or more other users from terminals of the one or more other users;
generating a public key using the public key share of the user and the public key shares of the one or more other users; and
encrypting plaintext using the public key.

6. The encryption apparatus of claim 5, wherein the generating of the public key share comprises:
generating a private key share of the user; and
generating a public key share of the user using the private key share of the user.

7. The encryption apparatus of claim 6, wherein the public key shares of the one or more other users are generated using private key shares of the one or more other users.

8. The encryption apparatus of claim 5, wherein the programs further include instructions for providing the generated public key share to the terminals of the one or more other users.

9. A decryption method performed by a computing apparatus including one or more processors and a memory for storing one or more programs executed by the one or more processors, the decryption method comprising:
generating a partial decryption result for a ciphertext encrypted with a public key by using a private key share of a user;
requesting terminals of one or more other users to perform partial decryption of the ciphertext;
receiving partial decryption results for the ciphertext using private key shares of the one or more other users from the one or more other user terminals; and
generating plaintext for the ciphertext using the generated partial decryption result and the partial decryption results received from the one or more other users.

10. The decryption method of claim 9, wherein the public key is generated using a public key share of the user and public key shares of the one or more other users.

11. The decryption method of claim 10, wherein the public key share of the user is generated using the private key share of the user; and
the public key shares of the one or more other users are generated using the private key shares of the one or more other users.

12. The decryption method of claim 9, wherein the ciphertext is a ciphertext generated by evaluating a plurality of ciphertexts encrypted with the public key in an encrypted state.

13. The decryption method of claim 12, wherein the plaintext is a result of performing evaluation on plaintexts for the plurality of ciphertexts.

14. The decryption method of claim 12, wherein the ciphertext is a ciphertext generated by adding a plurality of ciphertexts encrypted with the public key in an encrypted state.

15. The decryption method of claim 14, wherein the plaintext is a result of adding plaintexts for the plurality of ciphertexts.

16. The decryption method of claim 15, wherein the generating of the plaintext comprises generating plaintext for the ciphertext by adding the generated partial decryption result and the partial decryption results received from the one or more other users.

17. A decryption apparatus comprising:
one or more processors;
a memory; and
one or more programs,
wherein the one or more programs are stored in the memory and executed by the one or more processors; and
the program comprises instructions for:
generating a partial decryption result for a ciphertext encrypted with a public key by using a private key share of a user;
requesting terminals of one or more other users to perform partial decryption of the ciphertext;
receiving partial decryption results for the ciphertext using private key shares of the one or more other users from the one or more other user terminals; and
generating plaintext for the ciphertext using the generated partial decryption result and the partial decryption results received from the one or more other users.

18. The decryption apparatus of claim 17, wherein the public key is generated using a public key share of the user and public key shares of the one or more other users.

19. The decryption apparatus of claim 18, wherein the public key share of the user is generated using the private key share of the user; and
the public key shares of the one or more other users are generated using the private key shares of the one or more other users.

20. The decryption apparatus of claim 17, wherein the ciphertext is a ciphertext generated by evaluating a plurality of ciphertexts encrypted with the public key in an encrypted state.

21. The decryption apparatus of claim 20, wherein the plaintext is a result of performing evaluation on plaintexts for the plurality of ciphertexts.

22. The decryption apparatus of claim 20, wherein the ciphertext is a ciphertext generated by adding a plurality of ciphertexts encrypted with the public key in an encrypted state.

23. The decryption apparatus of claim 22, wherein the plaintext is a result of adding plaintexts for the plurality of ciphertexts.

24. The decryption apparatus of claim 23, wherein the generating of the plaintext comprises generating plaintext for the ciphertext by adding the generated partial decryption result and the partial decryption results received from the one or more other users.
